(19) United States
(12) Patent Application Publication
(10) Pub. No.: US 2017/0028361 A1
(43) Pub. Date: Feb. 2, 2017

(54) PTFE/PFSA BLENDED MEMBRANE

(71) Applicant: Pall Corporation, Port Washington, NY (US)

(72) Inventors: Andrew T. SITTERER, Massapequa, NY (US); Amarnauth SINGH, Selden, NY (US)

(21) Appl. No.: 14/815,031

(22) Filed: Jul. 31, 2015

(51) Int. Cl. B01D 71/36; C08J 9/00; B29C 55/00; B01D 71/66; B01D 67/00

(52) U.S. Cl. CPC B01D 71/36; B01D 71/66; B01D 67/0095; B01D 67/0086; B29C 55/005; C08J 9/0066; B29K 2027/18

(57) ABSTRACT

A porous membrane comprising PTFE blended with PFSA is disclosed.

### BACKGROUND OF THE INVENTION

PTFE membranes, particularly expanded PTFE (ePTFE) membranes, are used in a variety of liquid and gas filtration applications, including applications that involve treating challenging fluids such as corrosive or chemically active liquids. However, there is a need for porous membranes that can filter hot sulfuric perioxide mixture (SPM) fluids and/or exhibit metal scavenging or metal removal efficiency while providing low flow resistance.

These and other advantages of the present invention will be apparent from the description as set forth below.

### BRIEF SUMMARY OF THE INVENTION

An embodiment of the invention provides a porous membrane comprising PTFE blended with perfluorosulfonic acid (PFSA), wherein the membrane has a CWST of at least about 27 dynes/cm (about 27×10⁻⁵ N/cm), in some embodiments, at least about 30 dynes/cm (about 30×10⁻⁵ N/cm).

In another embodiment, a method for filtering a sulfuric perioxide mixture (SPM) fluid is provided, the method comprising passing the fluid through a porous membrane comprising PTFE blended with perfluorosulfonic acid (PFSA), wherein the membrane has a CWST of at least about 27 dynes/cm (about 27×10⁻⁵ N/cm), in some embodiments, at least about 30 dynes/cm (about 30×10⁻⁵ N/cm), and removes particles from the fluid.

In yet another embodiment, a method for filtering a metal-containing fluid is provided, the method comprising passing a metal-containing fluid through a porous membrane comprising PTFE blended with perfluorosulfonic acid (PFSA), wherein the membrane has a CWST of at least about 27 dynes/cm (about 27×10⁻⁵ N/cm), in some embodiments, at least about 30 dynes/cm (about 30×10⁻⁵ N/cm), and removes metal from the fluid.

Devices including the membranes, and methods of making the membranes, are also provided in accordance with embodiments of the invention.

### DETAILED DESCRIPTION OF THE INVENTION

In accordance with an embodiment of the present invention, a porous membrane comprises PTFE blended with perfluorosulfonic acid (PFSA), wherein the membrane has a CWST of at least about 27 dynes/cm (about 27×10⁻⁵ N/cm), in some embodiments, at least about 30 dynes/cm (about 30×10⁻⁵ N/cm).

In one embodiment of the membrane, the PFSA is cross-linked, in another embodiment, the PFSA is non-cross-linked.

In another embodiment, a method for filtering SPM fluid is provided, the method comprising passing the fluid through a porous membrane comprising PTFE blended with perfluorosulfonic acid (PFSA), wherein the membrane has a CWST of at least about 27 dynes/cm (about 27×10⁻⁵ N/cm), in some embodiments, at least about 30 dynes/cm (about 30×10⁻⁵ N/cm), and removes particles (such as silica-containing particles) from the fluid.

A method for filtering a metal-containing fluid according to an embodiment of the invention comprises passing a metal-containing fluid through a porous membrane comprising PTFE blended with perfluorosulfonic acid (PFSA), wherein the membrane has a CWST of at least about 27 dynes/cm (about 27×10⁻⁵ N/cm), in some embodiments, at least about 30 dynes/cm (about ×10⁻⁵ N/cm), and removes metal from the fluid. In some embodiments of the method, the membrane removes Group 2 metals (e.g., Mg and/or Ca), polyvalent metals and/or transition metals (e.g., Cr, Mn, Fe, and/or Ni) from the fluid.

In another embodiment, a method of making a membrane is provided, the method comprising combining PTFE resin with perfluorosulfonic acid (PFSA), optionally also including a lubricant; forming a tape; stretching the tape to produce a porous membrane; and, soaking the membrane in isopropyl alcohol.

In another embodiment, a method of preparing a porous membrane is provided, the method comprising preparing a blend comprising PTFE and PFSA, optionally with a lubricant; extruding the blend into a tape; biaxially stretching the tape to obtain the porous membrane; optionally annealing the porous membrane at a temperature of about 325° C. for about 5 minutes.

In some embodiments of making membranes according to the invention, a cross-linking agent is included, in other embodiments, a cross-linking agent is not used.

Advantageously, in contrast with the preparation of membranes for some applications wherein a metal agent is used, and the metal agent is removed by a post washing process (e.g., using HCl) to meet standards (e.g., in the microelectronics industry), membranes according to the invention can be prepared free of metal agents. Additionally, in contrast with membranes prepared with a coating, membranes according to the invention can be produced functional as made, and since there is no coating, the pore structure is not adversely affected. Moreover, membranes can be prepared according to the invention in a manufacturing friendly process, e.g., the preparation can be easily incorporated into existing manufacturing processes, resulting in increased speed of preparation.

Additionally, scanning electron micrographs of membranes according to the invention compared to control (non-blended) PTFE membranes show similar pore, fibril, and node structures.

The porous membranes according the invention advantageously provide a combination of high metal scavenging or metal removal efficiency and low flow resistance, while remaining wet in the fluid being processed (i.e., the membranes are non-dewetting in the process fluid) and are useful in a wide range of liquid, and gas (including air) filtration applications, including sterile filtration applications. Exemplary applications include for example, diagnostic applications (including, for example, sample preparation and/or diagnostic lateral flow devices), ink jet applications, lithography, e.g., as replacement for HD/UHMW PE based media, filtering fluids for the pharmaceutical industry, metal removal, production of ultrapure water, treatment of industrial and surface waters, filtering fluids for medical applications (including for home and/or for patient use, e.g., intravenous applications, also including, for example, filtering biological fluids such as blood (e.g., virus removal)), filtering fluids for the electronics industry (e.g., filtering photoresist fluids in the microelectronics industry and hot sulfuric perioxide mixture (SPM) fluids), filtering fluids for the food and beverage industry, beer filtration, clarification, filtering antibody- and/or protein-containing fluids, filtering nucleic acid-containing fluids, cell detection (including in situ), cell harvesting, and/or filtering cell culture fluids. Alternatively, or additionally, porous membranes according to embodiments of the invention can be used to filter air and/or gas and/or can be used for venting applications (e.g., allowing air and/or gas, but not liquid, to pass therethrough). Porous membranes according to embodiments of the inventions can be used in a variety of devices, including surgical devices and products, such as, for example, ophthalmic surgical products. The inventive membranes are dimensionally stable. In some embodiments, the porous PTFE membranes can be utilized individually, e.g., as unsupported membranes, and in other embodiments, the porous PTFE membranes can be combined with other porous elements and/or another component, to provide, for example, an article such as a composite, a filter element, and/or a filter.

One example of a suitable PFSA additive for use in blending with PTFE is available from Solvay Specialty Polymers (Borger, Tex.) as Aquivion® PFSA (e.g., AQUIVION PFSA D83-24B, AQUIVION PFSA D83-06A, and AQUIVION PFSA D79-20BS), which is based on a Short Side Chain (SSC) copolymer of Tetrafluoroethylene and a Sulfonyl Fluoride Vinyl Ether (SFVE) F2C═CF—O—CF2—CF2—SO2F. The ionomer dispersions contain its sulfonic acid form. Another example of a suitable PFSA additive is a DuPont™ Nafion® PFSA polymer dispersion.

In preparing the blend, the concentration of PFSA can be varied for different applications. Typically, the concentration is at least about 0.05%; preferably in the range of from about 1% to about 20% more preferably, in the range of from about 1% to about 4%.

A variety of PTFE resins (including commercially available resins) can be blended with PFSA in accordance with the invention. Preferably, a lubricant is included. A variety of lubricants and lubricant concentrations are suitable as is known in the art.

Membranes can be prepared as known in the art. If desired, in combining PFSA with PTFE, the PFSA additive can be sprayed with the PTFE resin (e.g., for improved distribution), before physical mixture with the lubricant.

For example, the required amount of a PTFE powder is mixed with a solution of PFSA in a suitable solvent, for example, an alcohol solvent such as methanol, ethanol, or isopropanol, to obtain a blend, which is then mixed with a lubricant such as odorless mineral spirits, e.g., Isopar G, and the resulting paste is subjected to shear, for example, in a twin roller, and formed into a billet under a pressure of about 300 psi or more, at least twice, each for a period of about 55 sec. The resulting billets are equilibrated at room temperature for about 12 hrs or more. The billets are then extruded into the desired shape. For example, extrusion is performed at 26 mm die gap size, maximum pressure and constant temperature of 55° C. resulting in a tube shaped PTFE tape. Next, the tube shaped tape is cut open along the central axis and re-rolled around a pipette, resulting in a new billet (non-compressed). The new billet is re-extruded at the same conditions as used during first extrusion process. This step is added to provide advantageous cross-directional mechanical properties to the PTFE tape. Calendaring is performed at 30° C. targeting a tape thickness of 9-10 mils and cut into 4×4″. The resulting tape is then dried at 125° C. for 1 h, whereby the lubricant is removed from the extruded tape.

The tape is then stretched, e.g., at the following conditions: Stretch ratio of machine direction (MD) and transverse direction (TD) is 3 at 300%/sec stretch rate. Temperature in the stretch oven is set to 150° C.

The stretched tape is then annealed. Annealing is conducted in the annealing oven, following which the tape is cooled. The porosity that is produced by the above stretching is retained upon cooling.

Without beyond bound to any particular theory, it is believed that soaking the membrane in isopropyl alcohol (IPA) exposes more of the surface for contact with the fluid to be treated, and improves metal scavenging capability.

The membranes can have any suitable pore structure, e.g., a pore size (for example, as evidenced by bubble point, or by K_{L} as described in, for example, U.S. Pat. No. 4,340,479, or evidenced by capillary condensation flow porometry), a mean flow pore (MFP) size (e.g., when characterized using a porometer, for example, a Porvair Porometer (Porvair plc, Norfolk, UK), or a porometer available under the trademark POROLUX (Porometer.com; Belgium)), a pore rating, a pore diameter (e.g., when characterized using the modified OSU F2 test as described in, for example, U.S. Pat. No. 4,925,572), or removal rating media. The pore structure used depends on the size of the particles to be utilized, the composition of the fluid to be treated, and the desired effluent level of the treated fluid.

Typically, the porous PTFE membranes according to the invention have a pore rating of about 1 micrometers or less, preferably (particularly for non-dewetting applications) in the range of from about 0.05 micrometers to about 0.02 micrometers, or less. For example, the membrane can be a nanoporous membrane, for example, a membrane having pores of diameter in the range from 1 nm to 100 nm.

Typically, the membrane has a thickness in the range of from about 0.2 to about 5.0 mils (about 5 to about 127 microns), preferably, in the range of from about 0.5 to about 1.0 mils (about 13 to about 25 microns), though membranes can be thicker or thinner than those values.

The porous membrane can have any desired critical wetting surface tension (CWST, as defined in, for example, U.S. Pat. No. 4,925,572). CWST can be measured by relying on a set of solutions of certain composition. Each solution has specific surface tension. The solution's surface tension ranges from 25 to 92 dyne/cm in small non-equivalent increments. To measure the membrane surface tension, the membrane is positioned on to top of white light table, one drop of a solution of certain surface tension is applied to the membrane surface and the time the drop takes to penetrate through the membrane and become bright white as an indication of light going through the membrane is recorded. Instant wetting is considered when the time the drop takes to penetrate the membrane is ≦10 seconds. If the time >10 seconds, the solution is considered to partially wet the membrane. The CWST can be selected as is known in the art, e.g., as additionally disclosed in, for example, U.S. Pat. Nos. 5,152,905, 5,443,743, 5,472,621, and 6,074,869.

Typically, the membrane has a CWST of at least about 27 dynes/cm (about 27×10⁻⁵ N/cm), more preferably, at least about 30 dynes/cm (about 30×10⁻⁵ N/cm), and in some embodiments, at least about 35 dynes/cm (about 35×10⁻⁵ N/cm). For example, the membrane may have a CWST in the range of from about 30 dynes/cm (about 30×10⁻⁵ N/cm) to about 40 dynes/cm (about 40×10⁻⁵ N/cm), or more.

The membrane has first porous surface and a second porous surface, and a bulk between the first porous surface and the second porous surface, wherein the bulk comprises PTFE blended with PFSA.

An article such as a filter, filter element and/or composite including the porous membrane can include additional elements, layers, or components, that can have different structures and/or functions, e.g., at least one of any one or more of the following: prefiltration, support, drainage, spacing and cushioning. Illustratively, the filter can also include at least one additional element such as a mesh and/or a screen.

In accordance with embodiments of the invention, the membrane, filter element, composite and/or filter can have a variety of configurations, including planar, pleated, spiral, and/or hollow cylindrical.

The membrane, filter element, composite and/or filter is typically disposed in a housing comprising at least one inlet and at least one outlet and defining at least one fluid flow path between the inlet and the outlet, wherein the membrane is across the fluid flow path, to provide a filter device. Preferably, for crossflow applications, the membrane, composite and/or filter is disposed in a housing comprising at least one inlet and at least two outlets and defining at least a first fluid flow path between the inlet and the first outlet, and a second fluid flow path between the inlet and the second outlet, wherein the membrane is across the first fluid flow path, to provide a filter device. The filter device may be sterilizable. Any housing of suitable shape and providing at least one inlet and at least one outlet may be employed.

The housing can be fabricated from any suitable rigid impervious material, including any impervious thermoplastic material, which is compatible with the fluid being processed. For example, the housing can be fabricated from a metal, such as stainless steel, or from a polymer. In an embodiment, the housing is a polymer, such as an acrylic, polypropylene, polystyrene, or a polycarbonated resin.

The following examples further illustrate the invention but, of course, should not be construed as in any way limiting its scope.

### EXAMPLE 1

This example demonstrates a method of preparing membranes blended with different concentrations of PFSA according to embodiments of the invention.

PTFE resin is mixed with 15 phr lubricant (EXXOL D80) and PFSA additive at concentrations of 5 phr, 10 phr, and 20 phr (24% w/w; AQUIVION PFSA 24; D83-24B Solvay Plastics), for 20 minutes and equilibrated for 12 hours.

Billets are formed by pressuring the mixture twice at 20 bars for 55 seconds, and equilibrated for 12 hours at room temperature.

Extrusion is performed at 26 mm gap size, maximum pressure and constant temperature of 55° C. resulting in tube-shaped PTFE tapes. The tubes are cut open along the central axis and re-rolled around a pipette, resulting in new billets. The billets are re-extruded with same conditions as used during first extrusion process.

Calendaring is performed at room temperature to a resulting tape thicknesses of 9-10 mils with 4×4 inch in length and width dimensions. Tapes are dried at 125° C. for 1 hour. Tapes are stretched such that stretch ratios of both machine direction (MD) and transverse direction (TD) ratios are 1.5 and 3.0, at 300%/sec stretch rate. The temperature in the stretch oven is set to 150° C., and annealing is conducted in the annealing oven at 350° C. for 5 seconds.

Membranes are soaked for 5 days in 1:1 isopropyl alcohol (IPA):deionized (DI) water.

The membrane with the highest PFSA concentration (20 phr) is challenged in static mode with sulfuric perioxide mixture (SPM) at 140° C. for 3 hours.

Membranes are washed in DI water overnight and dried (including the SPM challenged membrane) at 160° C. for 10 min.

The results (compared to an untreated (control) PTFE membrane without blending with PFSA) are as follows:

| membrane | CWST range (dynes/cm²) |
|---|---|
| Control PTFE, no PFSA | 25-27 |
| PFSA content 5 phr (w/w) | 31-33 |
| PFSA content 10 phr (w/w) | 31-33 |
| PFSA content 20 phr (w/w) | 31-33 |
| After IPA:DI soak (PFSA 5 phr) | 31-35 |
| After IPA:DI soak (PFSA 20 phr) | 35-41 |
| After static SPM challenge (PFSA 20 phr) | 35-41 |

This example shows CWST is stably increased, providing non-dewetting membranes, even after exposure to SPM, in accordance with an embodiment of the invention.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A porous membrane comprising PTFE blended with perfluorosulfonic acid (PFSA), wherein the membrane has a CWST of at least about 27 dynes/cm (about 27×10⁻⁵ N/cm).

2. The porous membrane of claim 1, having a CWST of at least about 30 dynes/cm (about 30×10⁻⁵ N/cm).

3. A method for filtering a metal-containing fluid, the method comprising passing a metal-containing fluid through a porous membrane comprising PTFE blended with perfluorosulfonic acid (PFSA), wherein the membrane has a CWST of at least about 27 dynes/cm (about 27×10⁻⁵ N/cm).

4. The method of claim 3, wherein the metal-containing fluid is a fluid used in the electronics industry.

5. The method of claim 3, comprising removing Group 2 metals and/or transition metals from the metal-containing fluid.

6. A method for filtering a SPM fluid, the method comprising passing the SPM fluid through a porous membrane comprising PTFE blended with perfluorosulfonic acid (PFSA), wherein the membrane has a CWST of at least about 30 dynes/cm (about 30×10⁻⁵ N/cm).

7. The method of claim 6, comprising removing metal from the fluid.

8. The method of claim 7, comprising removing Group 2 metals and/or transition metals from the metal-containing fluid.

9. A method of making a porous membrane, the method comprising combining PTFE resin with perfluorosulfonic acid (PFSA), optionally also including a lubricant;
forming a tape;
stretching the tape to produce a porous membrane; and,
soaking the porous membrane in isopropyl alcohol (IPA).

10. The method of claim 9, further comprising drying the membrane. Please add the following claim:

11. The method of claim 4, comprising removing Group 2 metals and/or transition metals from the metal-containing fluid.
